(19) United States
(12) Patent Application Publication
(10) Pub. No.: US 2008/0284379 A1
(43) Pub. Date: Nov. 20, 2008

(54) BATTERY CHARGER AND METHOD

(76) Inventor: Hiroshi Hirano, Shizuoka-ken (JP)

Correspondence Address: Ernest A. Beutler, 10 Rue Marseille, Newport Beach, CA, 92660-8016, US

(21) Appl. No.: 11/848,419

(22) Filed: Aug. 31, 2007

(30) Foreign Application Priority Data
Sep. 4, 2006 (JP) JP2006-239602

(51) Int. Cl. H02J 7/04

(52) U.S. Cl. 320/150

(57) ABSTRACT

[Problem to be Solved] To efficiently charge a battery via a charger at a higher possible charging current that is within the range where no trouble due to the temperature occurs in the charger.

[Solution] There is provided a charger 10 that can charge a battery 3 of a vehicle 1 with a charging current A from a power source 8, and that is not mounted on board. In charging the battery 3, charging modes M1 to M4 are switched sequentially at a plurality of predetermined timings H1 to H5 as a charging time H elapses. Generally over the entire charging time H, values of the charging current A for the respective charging modes M1 to M4 are reduced as the charging time H elapses. Charging in a charging mode M1 is stopped when the temperature T of the charger 10 is increased to reach a predetermined temperature T1, so that charging is performed at a first lower charging current A1′ that is lower than the first charging current A1 for the preceding first charging mode M1 until a start predetermined timing H2 for a subsequent charging mode M2 that was to follow the preceding charging mode M1 is reached.

### TECHNICAL FIELD

The present invention relates to a charging control method for a vehicle that can efficiently charge an onboard battery via a charger by control in consideration of the temperature of the charger.

### BACKGROUND ART

A conventional charging control device for a vehicle is disclosed in Patent Document 1 mentioned below. The vehicle according to the publication is a golf cart, and includes an electric motor for driving the vehicle to run, a battery for discharging (supplying) electricity to the electric motor, and a motor controller for controlling the electricity supplied from the battery to the electric motor to a desired value in response to the amount of operation input to an operation section such as an accelerator pedal by a golfer.

A charger that is not mounted on the vehicle is provided. The charger can charge the battery with a charging current supplied from the power source. As shown in FIG. 2 of Patent Document 1, the charger includes a power supply control device for allowing and prohibiting the flow of the charging current from the power source to the battery to set the charging current to any value. The power supply control device has a switching means. The power supply control device is controlled according to the discharging condition (charging state) of the battery in order for the battery to be efficiently charged with a higher possible charging current under various conditions.

Specifically, a control signal (number of pulses, pulse width) in accordance with the discharging condition of the battery is input to the switching means of the power supply control device. Then, the switching operation of the switching means turns ON and OFF the power supply control device to allow and prohibit the flow of the charging current from the power source to the battery. In this way, the charging current is set to a desired value. In this case, the number of ON operation of the power supply control device increases as the number of pulses is larger, and the duration of the ON state increases as the pulse width is longer, increasing the value of the charging current.

In general, the vehicle is used on a golf course as follows. First, a golfer gets on the vehicle, and operates the operation section such as an accelerator pedal. Then, a desired amount of electricity is supplied from the battery to the electric motor in response to the amount of operation input to the operation section under control by the motor controller, so as to drive the electric motor. As the electric motor is driven in this way, the vehicle can be run at a speed desired by the operator.

The above vehicle departs from a predetermined location on a golf course, is used during a day's round of golf, and then is returned to the predetermined location. In this case, electricity in the battery of the vehicle has been discharged to the electric motor, and reduced to about 80%, in general, of the electricity storage capacity. Therefore, the battery is charged via the charger. The battery is charged to its full capacity, in general, so that the battery can discharge sufficient electricity to the electric motor the next day.

In general, the battery is charged as follows. The battery is charged using a multi-stage charging method in which charging modes are switched sequentially at a plurality of predetermined timings as the charging time elapses, and in which values of the charging current for the respective charging modes are reduced as the charging time elapses generally over the entire charging time (see Patent Document 2 mentioned below) This charging method is said to offer efficient charging.

[Patent Document 1] JP-A-2004-221521

[Patent Document 2] Specification of Japanese Patent Application No. 2006-70506

### DISCLOSURE OF THE INVENTION

### Problem to be Solved by the Invention

While the battery is being charged by the charger, the power supply control device of the charger is repetitively turned ON and OFF according to the number of pulses given in the control signal. Therefore, the temperature of the power supply control device tends to be high.

Here, it is known that as the temperature of the power supply control device becomes higher, the value of the charging current that flows via the power supply control device to the battery tends to be reduced relative to the number of pulses and the pulse width.

Thus, it is conceivable to increase the number of pulses and the pulse width in an attempt to bring the charging current to a desired value. In this way, however, the increase in the temperature of the power supply control device is accelerated. Thus, the temperature of the power supply control device becomes even higher, which may unfavorably lead to trouble in the power supply control device in an early stage.

### Means for Solving the Problem

The present invention has been made in view of the foregoing circumstances, and therefore has an object to efficiently charge a battery via a charger at a higher possible charging current that is within the range where no trouble due to the temperature occurs in the charger.

As shown by way of example in FIGS. 1 to 3, the invention of claim 1 provides a charging control method for a vehicle 1, the vehicle 1 including a battery 3 for discharging a charging current A to an electric motor 2 for driving the vehicle 1 to run, and a charger 10, which is not mounted on the vehicle 1, for charging the battery 3 with a charging current A from a power source 8, wherein the battery 3 is charged by the charger 10 in charging modes M1 to M4 that are switched sequentially at a plurality of predetermined timings H1 to H5 as a charging time H elapses, and values A1 to A3 of the charging current A for the respective charging modes M1 to M4 are reduced as the charging time H elapses generally over the entirety of the charging time H,

characterized in that charging in a charging mode M1 is stopped when a temperature T of the charger 10 is increased to reach a predetermined temperature T1 (H1′), so that charging is performed at a lower charging current A1′ that is lower than a charging current A1 for the preceding charging mode M1 until a start predetermined timing H2 for a subsequent charging mode M2 that was to follow the preceding charging mode M1 is reached.

As shown by way of example in FIGS. 1 to 3, the invention of claim 2 provides the invention of claim 1, the vehicle further including a cooling fan 35 for cooling the charger 10, the cooling fan 35 being driven when the temperature T of the charger 10 is increased to reach a higher predetermined temperature T2 that is higher than the predetermined temperature T1 (H2″).

As shown by way of example in FIGS. 1 to 3, the invention of claim 3 provides the invention of claim 2, in which the charging is stopped when the temperature T of the charger 10 is increased to reach a further higher predetermined temperature T3 that is higher than the higher predetermined temperature T2 (H2′″).

As shown by way of example in FIGS. 1, 2 and 4, the invention of claim 4 provides the invention of claim 1, in which the charging at the lower charging current A1′ is stopped so that charging is performed in the charging mode M1 again in a case where the temperature T of the charger 10 is increased to once reach the predetermined temperature T1 and then reaches a lower predetermined temperature T4 that is lower than the predetermined temperature T1, and where the lower predetermined temperature T4 is reached before a termination predetermined timing H2 for the charging mode M1 in which the charging at the lower charging current A1′ was started.

As shown by way of example in FIGS. 1, 2 and 5, the invention of claim 5 provides the invention of claim 1, in which the charging is stopped in a case where the temperature T of the charger 10 does not reach a lower predetermined temperature TL before a predetermined time HL elapses after the charging was started.

Reference numerals and symbols attached to the terms in this section are not intended to limit the technical scope of the present invention to the description in the “Embodiment” sections below and the drawings.

### EFFECT OF THE INVENTION

The effect of the present invention is as follows.

The invention according to claim 1 provides a charging control method for a vehicle, the vehicle including a battery for discharging a charging current to an electric motor for driving the vehicle to run, and a charger, which is not mounted on the vehicle, for charging the battery with a charging current from a power source, wherein the battery is charged by the charger in charging modes that are switched sequentially at a plurality of predetermined timings as a charging time elapses, and values of the charging current for the respective charging modes are reduced as the charging time elapses generally over the entirety of the charging time,

characterized in that charging in a charging mode is stopped when a temperature of the charger is increased to reach a predetermined temperature, so that charging is performed at a lower charging current that is lower than a charging current for the preceding charging mode until a start predetermined timing for a subsequent charging mode that was to follow the preceding charging mode is reached.

Therefore, since the charging current is reduced as described above when the temperature of the charger is increased during the charging using the charger, the load on the charger is reduced to suppress the increase in the temperature of the charger.

Thus, it is possible to prevent the temperature of the charger from becoming high, and to prevent the charger from easily getting broken by such high temperature, in the case of charging the battery using the charger. As a result, the battery can be efficiently charged at a higher possible charging current that is within the range where no trouble due to the temperature occurs in the charger.

In the invention according to claim 2, the vehicle further includes a cooling fan for cooling the charger, and the cooling fan is driven when the temperature of the charger is increased to reach a higher predetermined temperature that is higher than the predetermined temperature.

Therefore, even if the temperature of the charger would increase, the cooling fan would forcibly prevent the temperature from becoming high. Thus, it is possible to more reliably prevent the charger from easily getting broken by such high temperature. As a result, the battery can be efficiently charged at a higher possible charging current that is within the range where no trouble due to the temperature occurs in the charger.

In the invention according to claim 3, the charging is stopped when the temperature of the charger is increased to reach a further higher predetermined temperature that is higher than the higher predetermined temperature.

Therefore, it is possible to more reliably prevent the charger from being overheated and getting broken. In addition, it is possible to maintain or inspect the battery and the charger before the charger gets broken.

In the invention according to claim 4, the charging at the lower charging current is stopped so that charging is performed in the charging mode again in a case where the temperature of the charger is increased to once reach the predetermined temperature and then reaches a lower predetermined temperature that is lower than the predetermined temperature, and where the lower predetermined temperature is reached before a termination predetermined timing for the charging mode in which the charging at the lower charging current was started.

Therefore, since the increase in the temperature of the charger in this case is a “temporary event” that has occurred during the charging time in a certain charging mode, it is possible to prevent the charger from getting broken by the temperature.

In addition, in the case where the increase in the temperature of the charger due to the charging is a “temporary event” as described above, the charging mode is immediately switched to the first charging mode along with the reduction in the temperature, so that charging is performed at the first charging current, which is larger than the first lower charging current. Therefore, the battery can be efficiently charged at a higher possible charging current that is within the range where no trouble due to the temperature occurs in the charger.

In the invention according to claim 5, the charging is stopped in a case where the temperature of the charger does not reach a lower predetermined temperature before a predetermined time elapses after the charging was started.

During the charging using the charger, the temperature of the charger is normally increased. However, in the case where the temperature of the charger has not reached the lower predetermined temperature even if the predetermined time has elapsed since the start of the charging as described above, it is highly possible that the battery or the charger may be broken.

Thus, the charging is stopped at an early stage as described above. This firstly prevents the battery and the charger from getting broken to a larger degree. Secondly, this makes it possible to maintain or inspect the battery and the charger at an earlier stage so as to repair them more easily.

### BEST MODE FOR CARRYING OUT THE INVENTION

In order to achieve an object to efficiently charge a battery via a charger at a higher possible charging current that is within the range where no trouble due to the temperature occurs in the charger by using the charging control method for a vehicle according to the present invention, the best mode for carrying out the invention is as follows.

The vehicle includes a battery for discharging a charging current to an electric motor for driving the vehicle to run. A charger that is not mounted on the vehicle is provided. The charger can charge the battery with a charging current supplied from the power source. In charging the battery by the charger, charging modes are switched sequentially at a plurality of predetermined timings as a charging time elapses. Generally over the entire charging time, the charging current is reduced as the charging time elapses.

Charging in a charging mode is stopped when a temperature of the charger is increased to reach a predetermined temperature, so that charging is performed at a lower charging current that is lower than a charging current for the preceding charging mode until a predetermined start timing for a subsequent charging mode that was to follow the preceding charging mode is reached.

### FIRST EMBODIMENT

In order to explain the present invention in more detail, a first embodiment of the present invention will be described with reference to FIGS. 1 to 3 attached hereto.

In FIG. 1, reference numeral 1 denotes an electric vehicle that can run on a golf course, for example a golf cart.

The vehicle 1 includes an electric motor 2, supported by a vehicle body (not shown), for driving the vehicle to run, a lead battery 3 for discharging (supplying) electricity to the motor 2, an operation section 4 such as an accelerator pedal to be operated by an operator such as a golfer, and a motor controller 5 for electronically controlling the discharge amount of electricity from the battery 3 to the electric motor 2 to a desired value in response to the amount of operation input to the operation section 4 to drive the electric motor 2 into a desired state. The motor controller 5 includes a central processing unit (CPU) 6.

A charger 10 that is not mounted on the vehicle 1 is provided. The charger 10 receives electricity supplied from a power source 8 via a connector 9, and can charge the battery 3 with a charging current. The charger 10 includes a central processing unit (CPU) 11. The power source 8 is a commercial power source (100 VAC, 50/60 Hz) provided at a charging stand on a golf course.

A connector 14 that can connect/disconnect the battery 3 and the central processing unit 6 of the motor controller 5 to/from the charger 10 is provided. The connector 14 includes an input terminal 15 that is a receptacle provided on the side of the battery 3 and the motor controller 5, and an output terminal 16 that is a plug provided on the side of the charger 10 and connectable with the input terminal 15.

The input terminal 15 has three plug sockets 15a, 15b, 15c, while the output terminal 16 has three plugs 16a, 16b, 16c corresponding to the plug sockets 15a, 15b, 15c, respectively. Connecting two plug sockets 15a, 15b, of the plug sockets 15a, 15b, 15c, and two plugs 16a, 16b, of the plugs 16a, 16b, 16c, to each other allows the battery 3 to be charged with a charging current supplied from the power source 8 via the charger 10. Connecting the other plug socket 15c, of the plug sockets 15a, 15b, 15c, and the other plug 16c, of the plugs 16a, 16b, 16c, to each other allows electronic communication between the central processing unit 6 of the motor controller 5 and the central processing unit 11 of the charger 10.

Connecting the input terminal 15 and the output terminal 16 of the connector 14 allows the charging current supplied from the power source 8 to be controlled by the central processing unit 11 of the charger 10, allowing the battery 3 to be charged with the charging current via the plug sockets 15a, 15b and the plugs 16a, 16b of the connector 14.

The charger 10 includes a charging storage device 18 for storing previous charging history of the battery 3. The term “charging history” as used above refers to data of charging records such as charging current, charging time, etc., during the charging. In order to identify which one of a plurality of vehicles 1 available at a golf course corresponds to the charging history of the battery 3 stored in the charging storage device 18, an identification code of each vehicle 1 is stored in the charging storage device 18 along with the charging history. The charging storage device 18 of the charger 10 may not be able to identify which vehicle 1 is used during the charging.

The motor controller 5 includes a separate charging storage device 20 for storing previous charging history of the battery 3. Specifically, the charging history stored in the charging storage device 18 is sent as it is via the central processing unit 11 of the charger 10, the plug socket 15c and the plug 16c of the connector 14, and the central processing unit 6 of the motor controller 5 to be stored in the separate charging storage device 20.

During the charging, a signal output from the central processing unit 11 of the charger 10 may not be stored in the charging storage device 18 but be sent via the plug socket 15c and the plug 16c of the connector 14 and the central processing unit 6 of the motor controller 5 to be stored directly in the separate charging storage device 20. In this case, the charging storage device 18 may not be provided.

A display device 22 that is not mounted on the vehicle 1 is provided. The display device 22 may be a stationary personal computer or a portable information terminal that may be a personal computer. A connector 23 that can connect the central processing unit 6 of the motor controller 5 and the display device 22 to each other is provided. The connector 23 includes an input terminal 24 that is a receptacle provided on the side of the display device 22, and an output terminal 25 that is a cap provided on the side of the central processing unit 6 of the motor controller 5 and connectable with the input terminal 24.

A data signal representing the charging history stored in the separate charging storage device 20 and so forth can be output via the connector 23 to the display device 22. Outputting the data signal allows the charging history and information such as charging mode during the charging to be visibly displayed on the display device 22. The data signal may be output wirelessly from the central processing unit 6 of the motor controller 5 to the display device 22. The charging history stored in the charging storage device 18 may be displayed on the display device 22.

In order to charge anew the battery 3 of the vehicle 1 with the charging current supplied from the power source 8, first, the input terminal 15 and the output terminal 16 of the connector 14 are connected. Then, charging is performed anew in a new charging mode set based on the previous charging history stored in the separate charging storage device 20 of the motor controller 5 provided to the vehicle 1.

Specifically, in the case where the vehicle 1 departed from a predetermined value, and has run approximately a predetermined distance over approximately a predetermined time without trouble to return to the predetermined location, the battery 3 is charged anew by the charger 10 using a new charging mode with the same charging current and the same charging time as those of the previous charging history stored in either of the charging storage devices 18, 20. The charging history of this charging anew is stored in the charging storage devices 18, 20 as previous charging history.

Now, in the case where a trouble has occurred, for example the amount of electricity stored in the battery 3 is short, during subsequent running of the vehicle 1 under similar conditions to those described above, a new charging mode is set externally by an operation by an operator or automatically by the central processing unit 11 of the charger 10. In the new charging mode, the charging current may be increased or the charging time may be increased, for example, compared to the previous charging history stored in either of the charging storage devices 18, 20. Then, the battery 3 is charged further anew in this further new charging mode.

Here, in the case where the amount of electricity stored in the battery 3 is abnormally short during running of the vehicle 1, it is determined that an abnormality has occurred in the battery 3 or the charger 10.

While the battery 3 of the vehicle 1 is being charged, the charging storage device 18 of the charger 10 identifies which one of the plurality of vehicles 1 the subject vehicle 1 is, as described above. This allows the charging storage device 18 to extract the charging history of the identified vehicle 1. Therefore, in this case, it is not necessary to mount a separate charging storage device 20 on each vehicle 1, in other words, the separate charging storage device 20 may not be provided. In the case where there is only one vehicle 1 as a charging object of the charger 10, the charging history may be stored in only one of the charging storage devices 18, 20.

The charger 10 will be described in more detail with reference to FIG. 2.

The charger 10 includes an internal power supply circuit 28 for receiving a part of the electricity from the power source 8 to supply the part of the electricity to the central processing unit 11, a transformer 29 for receiving and transforming most of the other part of the electricity from the power source 8, a rectifier 30 for converting the electricity from the transformer 29 into a direct current, and a power supply control device 31 for allowing and prohibiting the flow of a charging current A from the rectifier 30 to the battery 3 to set the charging current A to any value. The power supply control device 31 has a switching means (FET; not shown).

A control signal (number of pulses, pulse width) of the central processing unit 11 of the charger 10 is input to the switching means. Then, the switching operation of the switching means turns ON and OFF the power supply control device 31 to allow and prohibit the flow of the charging current A from the power source 8 to the battery 3. In this way, the charging current A is set to a desired value.

The charger 10 additionally includes a voltage and a current sensor 32, 33 for detecting the voltage and current of the charging current A from the power supply control device 31 to the battery 3, a temperature sensor 34 for detecting the temperature of the power supply control device 31, and a cooling fan 35 that can be driven by the supply of the other part of the electricity from the internal power supply circuit 28, and that can cool the power supply control device 31, in particular, of the charger 10.

Respective detection signals from the voltage sensor 32, the current sensor 33 and the temperature sensor 34 are input to the central processing unit 11 of the charger 10, and the power supply control device 31 and the cooling fan 35 are each controlled based on the respective detection signals as follows.

With reference to FIG. 3, in charging the battery 3 using the charger 10, charging modes M1 to M4 are basically switched sequentially at a plurality of predetermined timings H1 to H5 as a charging time H elapses, as indicated by the solid line in FIG. 3. Generally over the entire charging time H, the charging current A is reduced as the charging time H elapses.

The current and voltage values of the charging current A set by the charger 10 are detected by the voltage and the current sensor 32, 33, and the detection values are fed back to the central processing unit 11 of the charger 10. This feedback is used to further control the power supply control device 31 of the charger 10, allowing the charging current A to be set to a more appropriate value.

Specifically, in a first charging mode M1, which lasts from a start predetermined timing H1 of the charging time H to a subsequent second predetermined timing H2, charging is performed at a first charging current A1, which is constant and large. In a second charging mode M2, which lasts from the second predetermined timing H2 to a subsequent third predetermined timing H2, charging is performed at a second charging current A2, which is constant and slightly lower than the first charging current A1.

In a third charging mode M3, which lasts from the third predetermined timing H3 to a subsequent fourth predetermined timing H4, charging is performed at values gradually linearly reduced from the second charging current A2 to a third charging current A3, which is much lower than the second charging current A2. In a fourth charging mode M4, which lasts from the fourth predetermined timing H4 to a subsequent fifth predetermined timing H5, charging is performed at the third charging current A3, which is constant.

In the case where the charging current at the time immediately before the third predetermined timing H3 (at which charging in the third charging mode M3 is started) is not the second charging current A2 for the second charging mode 2 but another charging current (a second lower charging current A2′ to be described later), charging in the third charging mode M3 is performed as follows.

In the third charging mode M3, charging is performed at values gradually linearly reduced from the another charging current to the third charging current A3 during the period from the third predetermined timing H3 to the fourth predetermined timing H (as indicated by the broken line in FIG. 3 to be described later).

More specifically, charging using the charger 10 is performed by controlling the power supply control device 31 by means of the central processing unit 11 of the charger 10 based on the detection signal representing the temperature T of the charger 10 detected by the temperature sensor 34, as follows.

Firstly, it is assumed that during the charging using the charger 10, the temperature T of the charger 10 is increased from an initial temperature T0 to reach a predetermined temperature T1 (H1′) as indicated by the dashed line in FIG. 3. Then, the charging in the first charging mode M1, which is being performed at this time, is stopped, so that charging is performed at a first lower charging current A1′, which is lower than the first charging current A1 for the preceding first charging mode M1 and higher than the second charging current A2 for the subsequent second charging mode M2, which was to follow the first charging mode M1, until the start predetermined timing H2 for the second charging mode M2 is reached. The first lower predetermined charging current A1′ may be approximately the same as the second charging current A2.

On the other hand, it is assumed that during the charging using the charger 10, the temperature T of the charger 10 is increased from the initial temperature T0 to reach the predetermined temperature T1 (H2′), and that the charging is being performed at that time in the second charging mode M2, as indicated by the broken line in FIG. 3. Then, the charging in the second charging mode M2, which is being performed at this time, is stopped, so that charging is performed at a second lower charging current A2′, which is lower than the second charging current A2 for the preceding second charging mode M2 and higher than the lowest value (third charging current A3) of the third charging current A3 for the subsequent third charging mode M3, which is to follow the second charging mode M2, until the start predetermined timing H3 for the third charging mode M3.

Then, when the charging at the second lower charging current A2′ is terminated (H3), charging in the subsequent third charging mode M3 is started. In the third charging mode M3, as described above, charging is performed at values gradually linearly reduced from the second lower charging current A2′ to the third charging current A3 (as indicated by the broken line in FIG. 3).

With the above configuration, since the charging current A is reduced as described above when the temperature T of the charger 10 is increased during the charging using the charger 10, the load on the charger 10 is reduced to suppress the increase in the temperature T of the charger 10.

Thus, it is possible to prevent the temperature T of the charger 10 from becoming high, and to prevent the charger 10 from easily getting broken by such high temperature, in the case of charging the battery 3 using the charger 10. As a result, the battery 3 can be efficiently charged at a higher possible charging current A that is within the range where no trouble due to the temperature T occurs in the charger 10.

Secondly, it is assumed that during the charging using the charger 10, the temperature T of the charger 10 is increased to reach a higher predetermined temperature T2 (H″), which is higher than the predetermined temperature T1, as indicated by the double-dashed line in FIG. 3. At this time, the cooling fan 35 is driven to cool with air the entire charger 10, mainly the power supply control device 31 of the charger 10.

Therefore, even if the temperature T of the charger 10 would increase, the cooling fan 35 would forcibly prevent the temperature T from becoming high. Thus, it is possible to more reliably prevent the charger 10 from easily getting broken by such high temperature. As a result, the battery 3 can be efficiently charged at a higher possible charging current A that is within the range where no trouble due to the temperature T occurs in the charger 10.

Thirdly, it is assumed that during the charging using the charger 10, the temperature T of the charger 10 is increased to reach a further higher predetermined temperature T3, which is further higher than the higher predetermined temperature T2 (H2′″), as indicated by the triple-dashed line in FIG. 3. At this time, the operation of the power supply control device 31 of the charger 10 is stopped to stop the charging using the charger 10.

Therefore, it is possible to more reliably prevent the charger 10 from being overheated and getting broken. In addition, it is possible to maintain or inspect the battery 3 and the charger 10 before the charger 10 gets broken.

FIGS. 4 and 5 to be explained below show second and third embodiments, respectively, of the present invention. The components, functions and effects of these embodiments are similar in many respects to those of the first embodiment. Therefore, components similar to those in the first embodiment are given the same reference numerals in the drawings and their description is not repeated, and their differences are mainly described below. The configuration of the components of the embodiments may be combined in various ways in the light of the objects, functions and effects of the present invention.

### SECOND EMBODIMENT

In order to explain the present invention in more detail, a second embodiment of the present invention will be described with reference to FIG. 4 attached hereto.

With reference to FIG. 4, it is assumed that during the charging in the first charging mode M1 of the charger 10, the temperature T of the charger 10 is increased to once reach the predetermined temperature T1 (H1′), as indicated by the dashed line in FIG. 4. Then, as described in the first embodiment, the charging in the first charging mode M1, which is being performed at this time, is stopped, so that charging is performed at the first lower charging current A1′ until the start predetermined timing H2 for the subsequent second charging mode M2, which was to follow the first charging mode M1, is reached (H1′ to H1″).

However, it is assumed that after once reaching the predetermined temperature T1, the temperature T reaches a lower predetermined temperature T4 (H1″), which is lower than the predetermined temperature T1, before reaching the higher predetermined temperature T2. Then, in the case where this timing (H1″) of the charging time H is before the second predetermined timing H2, which is a termination predetermined timing for the first charging mode M1, in which the charging at the first lower charging current A1′ was started, the charging at the first lower charging current A1′ is stopped so that charging in the first charging mode M1 is performed again (H1″ to H2).

In FIG. 4, during the charging in the second charging mode M2 of the charger 10, if the temperature T of the charger 10 is increased as indicated by the double-dashed line, the second lower charging current A2′, H2′ and H2″ in the same way as described above, charging is once performed at the second charging current A2′. When this results in a reduction in the temperature T of the charger 10, charging in the second charging mode M2 is performed again.

Therefore, since the increase in the temperature T of the charger 10 in each case described above is a “temporary event” that has occurred during the charging time H in a certain charging mode, it is possible to prevent the charger 10 from getting broken by the temperature T.

In addition, in the case where the increase in the temperature T of the charger 10 due to the charging is a “temporary event” as described above, the charging mode is immediately switched to the first charging mode M1 along with the reduction in the temperature T, so that charging is performed at the first charging current A1, which is larger than the first lower charging current A1′. Therefore, the battery 3 can be efficiently charged at a higher possible charging current A that is within the range where no trouble due to the temperature T occurs in the charger 10.

### THIRD EMBODIMENT

In order to explain the present invention in more detail, a third embodiment of the present invention will be described with reference to FIG. 5 attached hereto.

With reference to FIG. 5, during the charging using the charger 10, in the case where the temperature T of the charger 10 does not reach a lower predetermined temperature TL during the period from the first predetermined timing H1, which is the initial start timing of the charging, until a predetermined time HL is reached, as indicated by the dashed line in FIG. 5, the operation of the power supply control device 31 of the charger 10 is stopped to stop the charging.

During the charging using the charger 10, the temperature T of the charger 10 is normally increased. However, in the case where the temperature T of the charger 10 has not reached the lower predetermined temperature TL even if the predetermined time HL has elapsed since the start of the charging as described above, it is highly possible that the battery 3 or the charger 10 may be broken.

Thus, the charging is stopped at an early stage as described above. This firstly prevents the battery 3 and the charger 10 from getting broken to a larger degree. Secondly, this makes it possible to maintain or inspect the battery 3 and the charger 10 at an earlier stage so as to repair them more easily.

### BRIEF DESCRIPTION OF DRAWINGS

FIG. 1 is an electrical block diagram of a device in accordance with a first embodiment of the present invention.

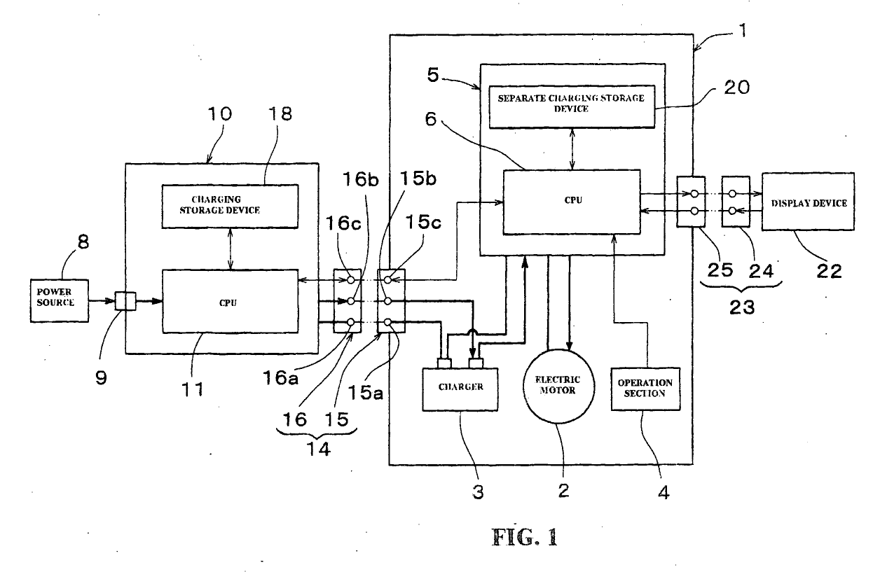

FIG. 2 is an electrical block diagram of a charger in accordance with the first embodiment.

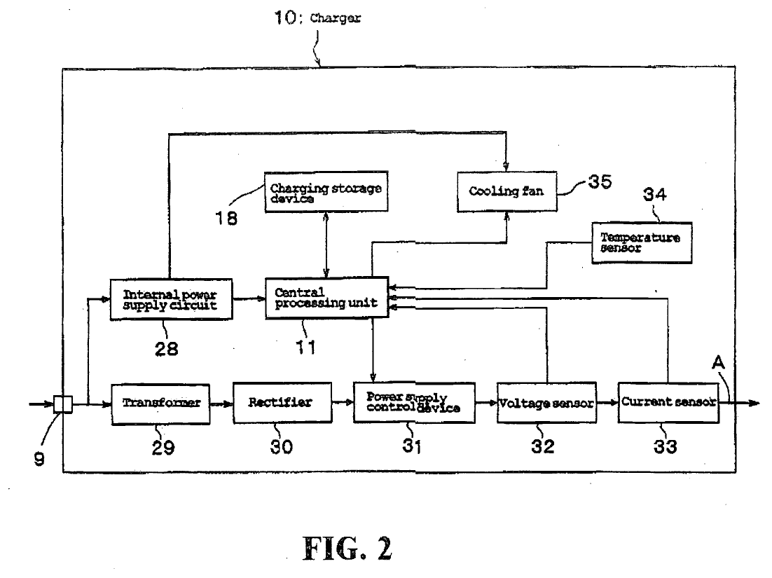

FIG. 3 is a graph illustrating charging control using the charger in accordance with the first embodiment.

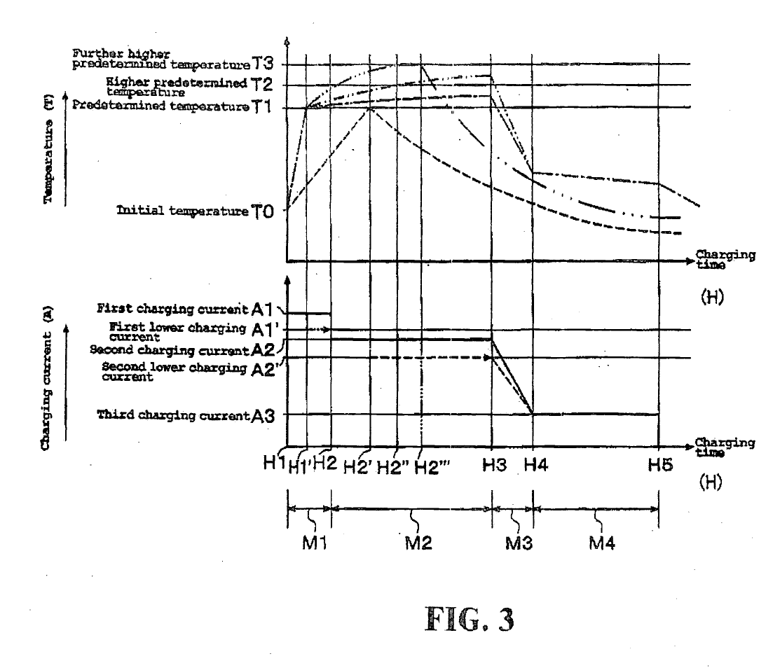

FIG. 4 is a counterpart of FIG. 3 in accordance with a second embodiment of the present invention.

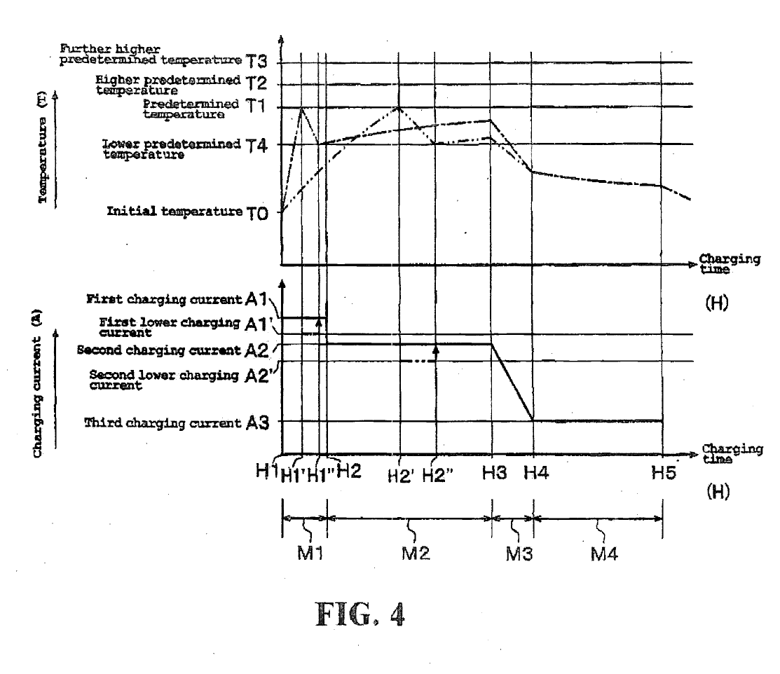

FIG. 5 is a counterpart of FIG. 3 in accordance with a third embodiment of the present invention.

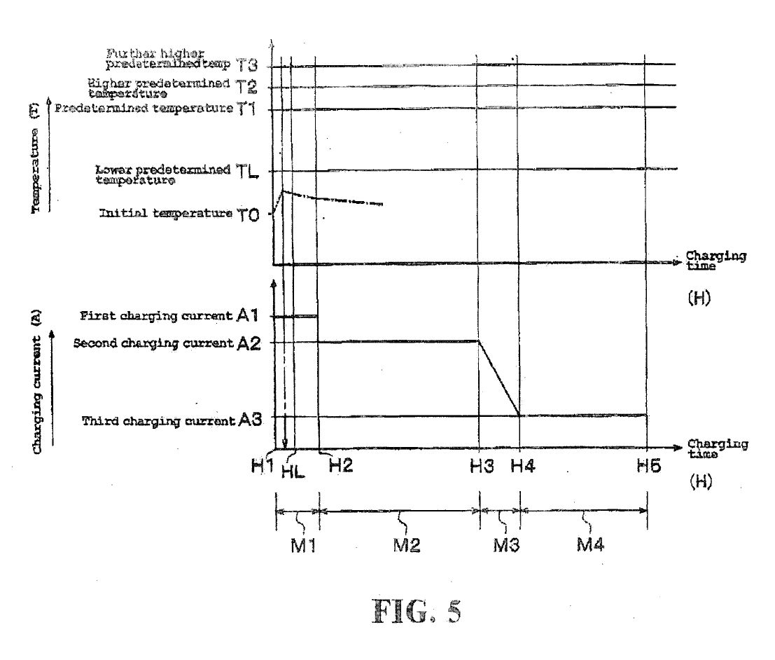

### DESCRIPTION OF REFERENCE NUMERALS

1: vehicle
2: electric motor
3: battery
4: operation section
5: motor controller
8: power source
10: charger
11: central processing unit
14: connector
15: input terminal
15a: plug socket
15b: plug socket
15c: plug socket
16: output terminal
16a: plug
16b: plug
16c: plug
18: charging storage device
20: separate charging storage device
22: display device
23: connector
31: power supply control device
32: voltage sensor
33: current sensor
34: temperature sensor
35: cooling fun
A: charging current
H: charging time
HL: predetermined time
T: temperature
T0: initial temperature
T1: predetermined temperature
T2: higher predetermined temperature
T3: further higher predetermined temperature
T4: lower predetermined set temperature
TL: lower predetermined temperature

1. A charging control method for a vehicle, the vehicle including a battery for discharging a charging current to an electric motor for driving the vehicle to run, and a charger, which is not mounted on the vehicle, for charging the battery with a charging current from a power source, wherein the battery is charged by the charger in charging modes that are switched sequentially at a plurality of predetermined timings as a charging time elapses, and values of the charging current for the respective charging modes are reduced as the charging time elapses generally over the entirety of the charging time,
characterized in that charging in a charging mode is stopped when a temperature of the charger is increased to reach a predetermined temperature, so that charging is performed at a lower charging current that is lower than a charging current for the preceding charging mode until a start predetermined timing for a subsequent charging mode that was to follow the preceding charging mode is reached.

2. The charging control method for a vehicle according to claim 1, the vehicle further including a cooling fan for cooling the charger, the cooling fan being driven when the temperature of the charger is increased to reach a higher predetermined temperature that is higher than the predetermined temperature.

3. The charging control method for a vehicle according to claim 2, wherein the charging is stopped when the temperature of the charger is increased to reach a further higher predetermined temperature that is higher than the higher predetermined temperature.

4. The charging control method for a vehicle according to claim 1, wherein the charging at the lower charging current is stopped so that charging is performed in the charging mode again in a case where the temperature of the charger is increased to once reach the predetermined temperature and then reaches a lower predetermined temperature that is lower than the predetermined temperature, and where the lower predetermined temperature is reached before a termination predetermined timing for the charging mode in which the charging at the lower charging current was started.

5. The charging control method for a vehicle according to claim 1, wherein the charging is stopped in a case where the temperature of the charger does not reach a lower predetermined temperature before a predetermined time elapses after the charging was started.
